(19) United States
(12) Patent Application Publication
(10) Pub. No.: US 2026/0261393 A1
(43) Pub. Date: Sep. 3, 2026

(54) TECHNIQUES FOR SECONDARY CELL ACTIVATION

(71) Applicant: QUALCOMM Incorporated, San Diego, CA (US)

(72) Inventors: Kianoush HOSSEINI, San Diego, CA (US); Changhwan PARK, San Diego, CA (US)

(21) Appl. No.: 19/536,700

(22) Filed: Feb. 11, 2026

Related U.S. Application Data
(60) Provisional application No. 63/765,148, filed on Feb. 28, 2025.

(51) Int. Cl. H04L 5/00; H04W 24/10; H04W 72/21; H04W 72/23

(52) U.S. Cl. CPC H04L 5/0098; H04W 24/10; H04W 72/21; H04W 72/23

(57) ABSTRACT

Methods, systems, and devices for wireless communications are described. In some cases, a user equipment (UE) may receive one or more control messages indicative of multiple secondary cells (SCells) and indicative of one or more activation parameters associated with SCell activation. Thus, the UE may select one or more SCells from the multiple SCells in accordance with the one or more activation parameters and may transmit a report indicative of the one or more SCells selected by the UE. Further, the UE may communicate one or more messages with the one or more SCells based on transmission of the report and based on activation of the one or more SCells.

### CROSS REFERENCE

The present Application for Patent claims the benefit of U.S. Provisional Patent Application No. 63/765,148 by HOSSEINI et al., entitled “TECHNIQUES FOR SECONDARY CELL ACTIVATION,” filed Feb. 28, 2025, assigned to the assignee hereof, and expressly incorporated herein.

### FIELD OF TECHNOLOGY

The following relates to wireless communications, including techniques for secondary cell (SCell) activation.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some cases, a user equipment (UE) may perform secondary cell (SCell) activation, deactivation, or both, based on control signaling from a primary cell (PCell). For example, the PCell may transmit, to the UE, a control message indicating one or more SCells to activate from a set of SCells. However, in such cases, latency associated with SCell activation may be dependent upon one or more conditions, such as a frequency range of the one or more SCells, whether the one or more SCells are known to the UE or unknown to the UE, or the like thereof, and at least a subset of the one or more conditions may be unknown to the PCell.

### SUMMARY

A method for wireless communications by a user equipment (UE) is described. The method may include receiving one or more control messages indicative of a set of multiple candidate secondary cells (SCells) and indicative of one or more activation parameters associated with secondary cell activation, selecting., by the UE, one or more SCells from the set of multiple SCells to be activated, where the selection is in accordance with the one or more activation parameters, and transmitting a report indicative of the one or more SCells of set of multiple candidate SCells based on the selection.

A UE for wireless communications is described. The UE may include one or more memories storing processor executable code, and one or more processors coupled with the one or more memories. The one or more processors may individually or collectively be operable to execute the code to cause the UE to receive one or more control messages indicative of a set of multiple candidate SCells and indicative of one or more activation parameters associated with secondary cell activation, selecting, by the UE, one or more SCells from the set of multiple SCells to be activated, where the selection is in accordance with the one or more activation parameters, and transmit a report indicative of the one or more SCells of set of multiple candidate SCells based on the selection.

Another UE for wireless communications is described. The UE may include means for receiving one or more control messages indicative of a set of multiple candidate SCells and indicative of one or more activation parameters associated with secondary cell activation, means for selecting, by the UE, one or more SCells from the set of multiple SCells to be activated, where the selection is in accordance with the one or more activation parameters, and means for transmitting a report indicative of the one or more SCells of set of multiple candidate SCells based on the selection.

A non-transitory computer-readable medium storing code for wireless communications is described. The code may include instructions executable by one or more processors to receive one or more control messages indicative of a set of multiple candidate SCells and indicative of one or more activation parameters associated with secondary cell activation and transmit a report indicative of activation of one or more SCells of set of multiple candidate SCells based on selection of the one or more SCells from set of multiple candidate SCells in accordance with the one or more activation parameters.

In some examples of the method, UE, and non-transitory computer-readable medium described herein, the one or more activation parameters include one or more threshold metrics and the method, apparatuses, and non-transitory computer-readable medium may include further operations, features, means, or instructions for monitoring set of multiple candidate SCells to generate one or more respective metrics associated with each secondary cell of set of multiple candidate SCells and selecting the one or more SCells from set of multiple candidate SCells based on one or more respective metrics associated with each secondary cell of the one or more SCells satisfying the one or more threshold metrics.

In some examples of the method, UE, and non-transitory computer-readable medium described herein, the one or more metrics include a reference signal received power, a reference signal received quality, a signal-to-interference and noise ratio, an energy of a signal, an interference over thermal, a duration of a measurement cycle, a duration of a reporting cycle, or any combination thereof.

In some examples of the method, UE, and non-transitory computer-readable medium described herein, selection of the one or more SCells from set of multiple candidate SCells may be in accordance with the one or more respective metrics associated with each secondary cell of the one or more SCells satisfying the one or more threshold metrics and being the greatest out of set of multiple candidate SCells.

In some examples of the method, UE, and non-transitory computer-readable medium described herein, a first activation parameter of the one or more activation parameters indicates that a second quantity of secondary cells from the set of multiple candidate secondary cells are to be activated by the UE, and wherein, to select the one or more secondary cells, the method, apparatuses, and non-transitory computer-readable medium may include operations, features, means, or instructions for selecting a first quantity of secondary cells of the set of multiple candidate secondary cells to be activated in accordance with each secondary cell of the first quantity of secondary cells satisfying a second activation parameter of the one or more activation parameters, where the first quantity of secondary cells is less than the second quantity of secondary cells, and where the report is indicative of the second activation parameter in accordance with the first quantity of secondary cells being less than the second quantity of secondary cells.

In some examples of the method, UE, and non-transitory computer-readable medium described herein, the one or more activation parameters correspond to activation of a first quantity of SCells and the method, apparatuses, and non-transitory computer-readable medium may include further operations, features, means, or instructions for selecting the one or more SCells from set of multiple candidate SCells in accordance with the one or more activation parameters and selecting one or more additional SCells for set of multiple candidate SCells, where the one or more additional SCells fail to satisfy the one or more activation parameters, where the one or more secondary cells and the one or more additional secondary cells, in combination, include the first quantity of secondary cells, and where the report may be indicates that the one or more additional SCells fail to satisfy the one or more activation parameters.

In some examples of the method, UE, and non-transitory computer-readable medium described herein, the one or more control messages indicate one or more tolerances associated with the one or more activation parameters and the method, apparatuses, and non-transitory computer-readable medium may include further operations, features, means, or instructions for selecting a first subset of the one or more secondary cells from the set of multiple candidate secondary cells in accordance with the first subset of the one or more secondary cells satisfying the one or more activation parameters, and for selecting a second subset of the one or more secondary cells from the set of multiple candidate secondary cells in accordance with the second subset of the one or more secondary cells satisfy the one or more activation parameters in accordance with the one or more tolerances.

Some examples of the method, UE, and non-transitory computer-readable medium described herein may further include operations, features, means, or instructions for transmitting a capability message indicative of a capability of the UE to select the one or more SCells from set of multiple candidate SCells in accordance with the one or more activation parameters, where reception of the one or more control messages may be based on transmission of the capability message.

Some examples of the method, UE, and non-transitory computer-readable medium described herein may further include operations, features, means, or instructions for receiving, from the primary cell, one or more second control messages indicative of one or more deactivation parameters associated with secondary cell deactivation and transmitting a second report indicative of deactivation of at least a subset of the one or more SCells that were activated based on selection of the subset from the one or more SCells in accordance with the one or more deactivation parameters.

Some examples of the method, UE, and non-transitory computer-readable medium described herein may further include operations, features, means, or instructions for selecting the one or more SCells from set of multiple candidate SCells in accordance with the one or more activation parameters and in accordance with one or more conditions associated with the UE, where the one or more conditions include a latency threshold associated with activation of the one or more SCells, a power level of the UE, a threshold quality associated with activation of the one or more SCells, or any combination thereof.

In some examples of the method, UE, and non-transitory computer-readable medium described herein, the one or more control messages may indicate a first subset of secondary cells from the set of multiple candidate secondary cells to be activated by the UE, where selection of the one or more secondary cells is from a remaining subset of secondary cells from the set of multiple candidate secondary cells based on reception of the indication of the first subset of secondary cells, and the method, apparatuses, and non-transitory computer-readable medium may include further operations, features, means, or instructions for communicating the one or more messages with the one or more SCells based on transmission of the report and with the first subset of SCells based on the indication of the first subset of SCells.

In some examples of the method, UE, and non-transitory computer-readable medium described herein, the one or more activation parameters includes a quantity of the one or more SCells to be activated, a quantity of SCells to be activated per frequency band, one or more frequency bands associated with the one or more SCells to be activated, one or more threshold bandwidths per secondary cell of the one or more SCells to be activated, a total bandwidth across the one or more SCells to be activated, one or more configuration parameters associated with the one or more SCells to be activated, one or more transmission directions associated with activation of the one or more SCells, a quantity of the one or more SCells to be activated in a primary uplink control group, a quantity of the one or more SCells to be activated in a secondary uplink control group, or any combination thereof.

In some examples of the method, UE, and non-transitory computer-readable medium described herein, the set of multiple candidate secondary cells may include a subset of candidate secondary cells from a second set of multiple candidate secondary cells.

In some examples of the method, UE, and non-transitory computer-readable medium described herein, the one or more control messages include an activation downlink control information message, an activation medium access control-control element message, an additional downlink control information message different than the activation downlink control information message, an additional medium access control-control element message different than the activation medium access control-control element message, a radio resource control message, or any combination thereof.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports techniques for secondary cell (SCell) activation in accordance with one or more aspects of the present disclosure.

FIG. 2 shows an example of a wireless communications system that supports techniques for SCell activation in accordance with one or more aspects of the present disclosure.

FIG. 3 shows an example of a process flow that supports techniques for SCell activation in accordance with one or more aspects of the present disclosure.

FIGS. 4 and 5 show block diagrams of devices that support techniques for SCell activation in accordance with one or more aspects of the present disclosure.

FIG. 6 shows a block diagram of a communications manager that supports techniques for SCell activation in accordance with one or more aspects of the present disclosure.

FIG. 7 shows a diagram of a system including a device that supports techniques for SCell activation in accordance with one or more aspects of the present disclosure.

FIG. 8 shows a flowchart illustrating methods that support techniques for SCell activation in accordance with one or more aspects of the present disclosure.

### DETAILED DESCRIPTION

In some cases, a user equipment (UE) may communicate with one or more network entities, which may be referred to as cells, including at least a primary cell (PCell) and optionally one or more secondary cells (SCells) from a set of SCells. In such cases, the PCell (e.g., or another activated SCell) may instruct the UE to dynamically activate, deactivate, or both, one or more SCells from the set of SCells via one or more control messages. For example, the PCell may transmit, to the UE, a control message indicating one or more SCells to activate from the set of SCells. However, in such cases, latency associated with SCell activation may be dependent upon one or more conditions, such as a frequency range of the one or more SCells, whether the one or more SCells are known to the UE or unknown to the UE, or the like thereof, and at least a subset of the one or more conditions may be unknown to the PCell. Thus, in some cases, the PCell (e.g., or the other activated SCell) may select one or more SCells from the set of SCells for the UE to activate based on one or more activation parameters and may transmit, to the UE, an indication of the one or more SCells selected by the PCell. However, the one or more SCells may be associated with greater latency than one or more other SCells (e.g., not indicated by the PCell) from the set of SCells that may also be capable of satisfying the one or more activation parameters.

Accordingly, techniques described herein may enable a UE to select one or more SCells, from the set of SCells, for activation based on one or more activation parameters (e.g., conditions) indicated to the UE, such that the UE may consider the one or more conditions known the UE when selecting the one or more SCells, thus reducing latency of SCell activation. For example, the UE may receive (e.g., from a PCell, from an activated SCell) a first control message indicating a set of SCells (e.g., configured SCells) and may receive a second control message (e.g., the same or different than the first control message) indicating one or more activation parameters associated with SCell activation. Thus, the UE may select one or more SCells from the set of SCells in accordance with the one or more activation parameters and may report the one or more SCells prior to (e.g., or before, or simultaneously with) activation of the one or more selected SCells.

In some cases, the one or more activation parameters may relate to one or more of a quantity of SCells to activate, a quantity of SCells per frequency band, per frequency band combination, per frequency range, or any combination thereof, to activate, one or more frequency bands from which the one or more SCells are to be selected, one or more threshold (e.g., minimum, maximum, or both) bandwidths per activated SCell, a total bandwidth across all activated SCells, or the like thereof. Additionally, or alternatively, the one or more activation parameters may indicate one or more threshold metrics (e.g., reference signal received power (RSRP), reference signal received quality (RSRQ), signal-to-interference and noise ratio (SINR), measurement cycle duration, reporting cycle duration). In such cases, the UE may measure each SCell in the set of SCells to generate one or more respective metrics associated with each SCell, and may select the one or more SCells based on one or more respective metrics associated with the one or more selected SCells satisfying the one or more threshold metrics.

Aspects of the disclosure are initially described in the context of wireless communications systems. Aspects of the disclosure are then described in the context of a process flow. Aspects of the disclosure are further illustrated by and described with reference to apparatus diagrams, system diagrams, and flowcharts that relate to techniques for SCell activation.

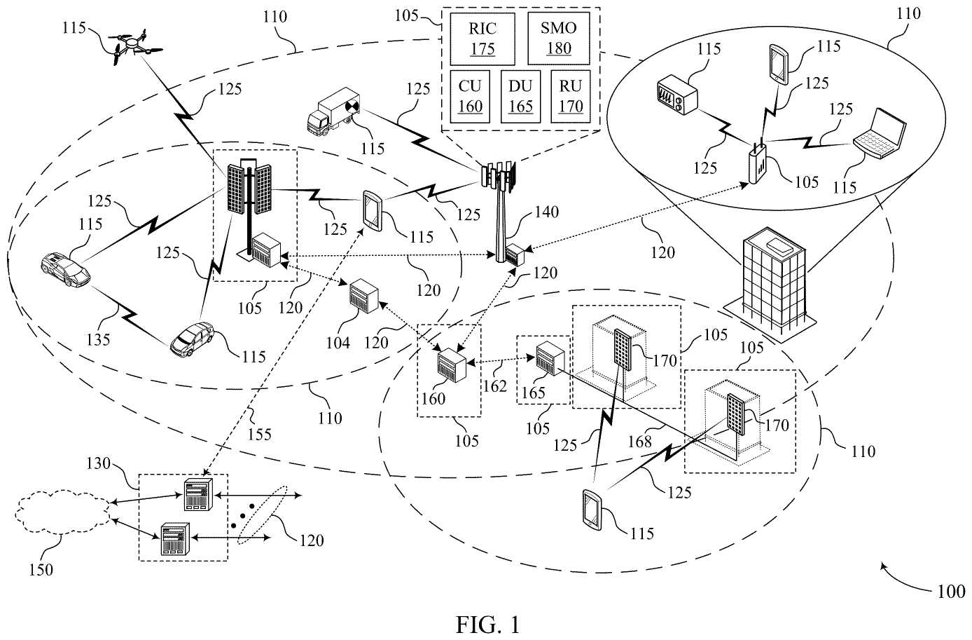

FIG. 1 shows an example of a wireless communications system 100 that supports techniques for SCell activation in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support techniques for SCell activation as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some examples, UEs 115 of the wireless communications system 100 may support activation and de-activation of SCells in accordance with one or more control messages. For example, in some cases (e.g., direction activation), a UE 115 may activate one or more SCells based on reception of an RRC message indicating a configuration of the one or more SCells. Additionally, or alternatively, (e.g., for enhance SCell activation/deactivation), a UE 115 may activate one or more first SCells, which may be referred to as activated SCells, deactivate one or more second SCells, which may be referred to as deactivated SCells, or both, based on reception of a control message, In such cases, the control message may be a medium access control (MAC)-control element (MAC-CE) message, a downlink control information (DCI) message, a radio resource control (RRC) message, or any combination thereof. For example, the UE 115 may receive an SCell activation/deactivation MAC-CE message (e.g., with temporary tracking reference signals TRSs)) indicating the activation of the one or more first SCells, deactivation of the one or more second SCells, or both. In some cases, a duration associated with activating the one or more first SCells, which may be referred to as an activation duration (e.g., time), may depend one measurement of one or more synchronization signal blocks (SSBs) from the one or more first SCells. However, in some cases (e.g., 5G), transmission of the one or more SSBs by the one or more SCells may be infrequent (e.g., sparse, at a frequency less than a threshold frequency). Thus, the SCell activation/deactivation MAC-CE message may trigger aperiodic TRS and the UE 115 may measure the aperiodic TRS for automatic gain control (AGC), time tracking, frequency tracking, or any combination thereof, instead of the one or more SSBs. Thus, with the aperiodic TRS, the UE may activate the one or more first SCells without waiting to receive (e.g., prior to receiving) the one or more SSBs, thus reducing the activation duration.

In some cases, the SCell activation/deactivation MAC-CE message may include a single octet (e.g., of a fixed size including seven cell index (e.g. SCellIndex) fields (C-fields) and one reserved field (R-field)) and the UE 115 may identify the SCell activation/deactivation MAC-CE message based on a MAC sub-header with a logical channel identifier (LCID) associated with SCell activation/deactivation. Alternatively, the SCell activation/deactivation MAC-CE message may include four octets (e.g., of a fixed size including thirty one C-fields and one R-field) and the UE 115 may identify the SCell activation/deactivation MAC-CE message based on a MAC sub-header with a logical channel identifier (LCID) associated with SCell activation/deactivation. In either case, each C-field (Cᵢ) may be associated with an index, i, (e.g., SCellIndex) such that a given C-field may indicate if an SCell associated with a same index, i, (e.g., associated with an SCellIndex i) is activated or deactivated (e.g., indicate an activation/deactivation status). For example, if a Cᵢ-field is set to 1, the UE 115 may activate an SCell with an SCell index of i. Conversely, if a Cᵢ-field is set to 0, the UE 115 may deactivate the SCell with the SCell index of i. To activate an SCell, the UE 115 may begin PDCCH monitoring on the SCell (e.g., and PDSCH monitoring) for one or more control messages. Conversely, to deactivate an SCell, the UE 115 may stop PDCCH monitoring (e.g., and PDSCH monitoring) on the SCell.

In some examples, the UE 115 may perform one or more first uplink operations, one or more first downlink operations, or both, on, or for, each activated SCell of the one or more activated SCells (e.g., one or more first SCells). For example, the UE 115 may transmit one or more sounding reference signal (SRSs) on each activated SCell of the one or more activated SCells, may perform channel state information (CSI) reporting for each activated SCell of the one or more activated SCells, may perform physical downlink control channel (PDCCH) monitoring on for each activated SCell of the one or more activated SCells, may perform PDCCH monitoring on each activated SCell of the one or more activated SCells, may perform one or more physical uplink control channel (PUCCH) transmissions on each activated SCell of the one or more activated SCells, or any combination thereof.

Conversely, the UE 115 may suspend (e.g., abort, refrain from performing) one or more second uplink operations, one or more second downlink operations, or both, on, or for, each deactivated SCell of the one or more deactivated SCells (e.g., one or more second SCells). For example, the UE 115 may refrain from transmitting the one or more SRS, one or more uplink messages on an uplink shared channel (UL-SCH), one or more PUCCH messages, one or more random access channel (RACH) messages, or any combination thereof, on each deactivated SCell of the one or more deactivated SCells, may refrain from performing CSI reporting on each deactivated SCell of the one or more deactivated SCells, may refrain from performing PDCCH monitoring on each deactivated SCell of the one or more deactivated SCells, may refrain from performing PDCCH monitoring for each deactivated SCell of the one or more deactivated SCells, or any combination thereof.

Additionally, or alternatively, the UE 115 may support SCell activation via bandwidth part (BWP) switching (e.g., to and from a dormant BWP). That is, the network entity 105 may indicate activation of the one or more first SCells via PDCCH-based activation instead of via MAC-CE-based activation (e.g., with periodic CSI measurement for AGC, time tracking, frequency tracking, and beam management). For example, the network entity 105 may configure (e.g., for the UE 115) a downlink BWP of an SCell as a dormant BWP via RRC signaling (e.g., dedicated RRC signaling, DormantBWP-Config). In the dormant BWP, the UE 115 may refrain from monitoring for PDCCH on the SCell, for the SCell, or both, but may continue to perform one or more CSI measurements, AGC, beam management, or any combination thereof, on the SCell (e.g., if configured). For example, for a dormant BWP, the UE 115 may refrain from performing PDCCH monitoring on the dormant BWP, may refrain from performing PDCCH monitoring for the dormant BWP, may refrain from receiving one or more transmissions on a downlink shared channel (DL-SH) on the dormant BWP, may refrain from transmitting one or more SRS, one or more uplink messages on an UL-SCH, one or more RACH messages, one or more PUCCH messages, or any combination thereof, on the dormant BWP, may refrain from performing aperiodic CSI reporting on the dormant BWP, or any combination thereof. However, the UE 115 may perform CSI reporting (e.g., except for aperiodic CSI) for the dormant BWP.

In such cases, SCell activation in accordance with a dormant BWP may reduce latency associated with SCell activation (e.g., as compared to MAC-CE-based SCell activation). For example, for MAC-CE-based SCell activation, the UE 115 may receive a PDCCH message followed by a PDSCH message including the MAC-CE for SCell activation and may transmit a feedback message (e.g., acknowledgment (ACK) message) in response to the PDSCH message. However, the UE 115 may not be ready to receive signaling from an activated SCell (e.g., indicated via the MAC-CE) until completion of a first duration associated with a MAC-CE level 2 (L2) procedure, RF retuning, RF warm-up, and a margin. Additionally, once the UE 115 is ready to receive signaling from the activated SCell, the UE 115 may not transmit a channel quality indicator (CQI) until after a second duration associated with AGC setting, master information block (MIB) reading, a margin, and performing a CQI reporting procedure. Conversely, for dormant BWP-based SCell activation, the UE 115 may receive a PDCCH indicative of a DCI for switching from a dormant BWP to an active BWP for an activated SCell and may be ready to receive signaling via the active BWP after completion of a third duration associated with RF retuning, RF warm up, and a margin, where the third duration is less than the first duration. Additionally, once the UE 115 is ready to receive signaling via the active BWP, the UE 115 may not transmit a CQI after a fourth duration associated with performing the CQI reporting procedure, where the fourth duration is less than the second duration.

In some cases, to enable scaling of UE throughout efficiently, the UE 115 may balance low latency with power consumption. That is, the UE 115 can achieve 0 ms latency by keeping all SCells, of a set of SCells configured for the UE 115, in an activated state (e.g., keeping all SCells activated). However, keeping all SCells in the activated state may result in increased power consumption due to the one or more uplink operations, one or more downlink operations, or both, performed by the UE 115 for each activated SCell. Conversely, the UE 115 can achieve low power consumption (e.g., as compared to when all SCells are kept active) by keeping all SCells, of the set of SCells configured for the UE 115, in an deactivated state. However, keeping all SCells in the deactivated state may result in increased latency due to SCell activation (e.g., defeating a purpose of aggregation due to applications reducing a data rate even before the network entity 105 may react and add a larger data pipe).

Thus, SCell activation latency associated with activation of an SCell, from the set of SCells configured for the UE 115, may be based on one or more factors. In such cases, the one or more factors may include a frequency range (FR) of the SCell, whether the SCell is known or unknown, a reporting period of the SCell, a measurement cycle of the SCell, an activation mechanism used to activate the SCell, whether the SCell is a PCell of a secondary PUCCH group, whether the SCell is in a different timing advance group (TAG) (e.g., that the network entity 105), one or more scheduling inefficiencies (e.g., waiting for multiple instances of CSI reporting before scheduling CSI-RS and transmission of the CSI report), or any combination thereof.

Thus, different timelines for SCell activation (e.g., SCell activation latency) may exist for different scenarios. For example, each of the following scenarios may be associated with a different timeline for SCell activation: SCell activation (e.g., and deactivation) of a known SCell in frequency range 1 (FR1) with a 160 ms SCell measurement cycle, SCell activation (e.g., and deactivation) of a known SCell in FR1 with a 320 ms SCell measurement cycle, SCell activation (e.g., and deactivation) of a unknown SCell in FR1, SCell activation (e.g., and deactivation) of multiple unknown SCells in FR1 with a single activation (e.g., or deactivation) command, and direct SCell activation (e.g., and deactivation) at SCell addition of a known SCell in FR1.

Although timelines for SCell activation may be different based on different scenarios, the UE 115 may report a non-zero CQI for each SCell once the SCell is activated. That is, once the UE 115 receives and applies an SCell activation/deactivation MAC-CE, the UE 115 may begin reporting CSI, where the UE 115 reports a non-zero CQI prior to a latest slot (e.g., defined based on HARQ timing, activation timing, and CSI report timing). However, the UE 115 may report a CQI index of 0 until the SCell activation is complete. That is, the UE 115 may begin reporting CSI with a CQI index of 0 until the SCell activation is complete, at which time the UE 115 may report a non-zero CQI index, where the UE 115 is to report the non-zero CQI index prior to the latest slot.

Additionally, the different timelines for SCell activation may consider a worst-case activation latency. That is, for each timeline, a network entity 105 may not expect the SCell to be activated until after a duration from a time at which the network entity 105 transmits an SCell activation command, where the duration satisfies a threshold (e.g., maximum) duration associated with the UE 115 activating the SCell. However, in some cases, the UE 115 may complete activation of the SCell prior to completion of the duration expected by the network entity 105. That is, the UE 115 may be in a ready state and operational on the activated SCell prior to completion of the duration. In such cases, the UE 115 may transmit an indication of the ready state to the network entity 105, such that the network entity 105 may initiate CSI acquisition and data scheduling on the SCell (e.g., earlier than defined by the duration). The UE 115 may be considered in the ready state when at least one of the following is satisfied: the UE 115 is ready to measure L1-RSRP based on one or more reference signals that are not periodic (e.g., aperiodic or semi-persistent CSI-RS), the UE 115 is ready to perform CSI measurement based on aperiodic or semi-persistent CSI-RS, the UE is ready to receive PDCCH or PDSCH, and the UE is ready to transmit a physical random access channel (PRACH) (e.g., if the SCell belongs to a different TAG than the network entity 105 such that the UE 115 performs an uplink synchronization procedure). In an example, for unknown SCell activation, L1-RSRP measurement and report may be performed after loop convergence, and the measurement may be based on A/SP-CSI-RS, for which the network entity 105 may decide when to start transmitting reference signals. Loop convergence may refer to a duration over which internal PHY control loops of the UE 115 (e.g., automatic gain control (AGC), time tracking loops, frequency tracking loops) settle to relatively stable and accurate values after an SCell becomes active, such that RSRP (e.g., and related measurements) are reliable.

In some cases, the wireless communications system 100 may support techniques to enable a UE 115 to select one or more SCells (e.g., one or more second network entities 105), from the set of SCells (e.g., a set of one or more second network entities 105), for activation based on one or more activation parameters (e.g., conditions) indicated to the UE 115. For example, the UE 115 may receive, from a network entity 105, a first control message indicating a set of SCells (e.g., configured SCells) and may receive a second control message (e.g., the same or different than the first control message) indicating one or more activation parameters associated with SCell activation. Thus, the UE 115 may select one or more SCells from the set of SCells in accordance with the one or more activation parameters and may report the one or more SCells prior to (e.g., after, or before, or simultaneously with) activation of the one or more selected SCells.

In some cases, the one or more activation parameters may relate to one or more of a quantity of SCells to activate, a quantity of SCells per frequency band to activate, one or more frequency bands from which the one or more SCells are to be selected, one or more threshold (e.g., minimum, maximum, or both) bandwidths per activated SCell, a total bandwidth across all activated SCells, or the like thereof. Additionally, or alternatively, the one or more activation parameters may indicate one or more threshold metrics (e.g., RSRP, RSRQ, SINR, measurement cycle duration, reporting cycle duration). In such cases, the UE 115 may measure each SCell in the set of SCells to generate one or more respective metrics associated with each SCell, and may select the one or more SCells based on one or more respective metrics associated with the one or more selected SCells satisfying the one or more threshold metrics.

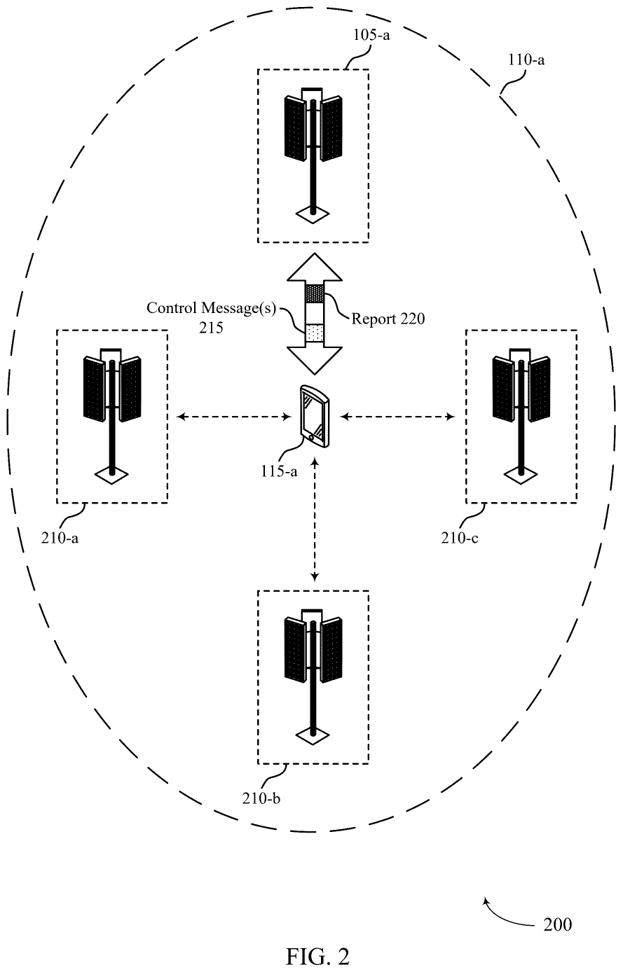

FIG. 2 shows an example of a wireless communications system 200 that supports techniques for SCell activation in accordance with one or more aspects of the present disclosure. In some cases, the wireless communications system 200 may implement or be implemented by aspects of the wireless communications system 100. For example, the wireless communications system 200 may include one or more UEs 115 (e.g., a UE 115-a) and one or more network entities 105 (e.g., a network entity 105-a, an SCell 210-a, an SCell 210-b, and an SCell 210-b), which may be examples of the corresponding devices as described herein. In some cases, the network entity 105-a may be a PCell, or may be another activated SCell 210 (e.g., SCell 210 currently activated by the UE 115-a).

In some cases, a UE 115, such as the UE 115-a, may communicate with one or more network entities 105 in a coverage area 110-a, which may be similarly referred to as cells, including at least a network entity 105-a and optionally one or more SCells 210 from a set of SCells 210 configured for the UE 115-a. For example, the UE 115-amay communicate with a network entity 105-a (e.g., a first network entity, a PCell, an activated SCell 210) and may be configured with a set of SCells 210 (e.g., a set of second network entities), including an SCell 210-a, an SCell 210-b, and an SCell 210-c, where the set of SCells 210 are not yet (e.g., currently) activated (e.g., are deactivated). In such cases, the network entity 105-a may instruct the UE 115-a to activate (e.g., or deactivate) one or more of the SCell 210-a, the SCell 210-b, and the SCell 210-c via one or more control messages 215. For example, the network entity 105-a may transmit, to the UE 115-a, a control message 215 (e.g., SCell activation command) indicating for the UE 115-a to activate the SCell 210-a and the SCell 210-b (e.g., a control message 215 indicating the SCell 210-a and the SCell 210-b).

However, as discussed herein, latency associated SCell activation may be dependent on one or more factors (e.g., SCell activation timelines may be dynamic) at a time at which the control message 215 is received. For example, the one or more factors may include one or more of a quantity of SCells 210 to be activated (e.g., added), which SCells 210 are to be activated, a relationship between the SCells 210 to be activated and one or more other already activated SCells 210 (e.g., an effective band combination), a synchronization signal (SS)/physical broadcast channel (PBCH) Block Measurement Timing Configuration (SMTC) of each SCell 210 to be activated, an SSB configuration of each SCell 210 to be activated, one or more measurement objects, or the like, or any combination thereof.

Additionally, at least a subset of the one or more factors may be unknown to the network entity 105-a, such that the network entity 105-a may not be aware of which of the SCells 210 may be able to be activated by the UE 115-a with the least amount of latency (e.g., out of the set of SCells 210). That is, even though the UE 115-a may be capable of transmitting an early indication of activation of one or more SCells 210 (e.g., indicated by the network entity 105-a via a control message 215), the network entity 105-a may not be aware of which SCells 210 are associated with a quickest activation duration (e.g., lowest SCell latency), such that a duration associated with activating one or more SCells 210 (e.g., even with the early indication) may be greater than a duration associated with activating one or more other SCells 210. In other words, the network entity 105-a may indicate, to the UE 115-a via a control message 215, one or more SCells 210 to be activated, but how fast the one or more SCells 210 can be activated by the UE 115-a may be based on (e.g., up to) the UE 115-a.

Additionally, or alternatively, in many cases, when the network entity 105-a configures the set of SCells 210 for the UE 115-a (e.g., the multiple SCells 210), activation of one or more SCells 210 (e.g., of the set of SCells 210) may be based on the network entity 105-a enabling access to a larger BW (e.g., than when less SCells 210 are activated), such that activation of multiple different SCells 210 or multiple different combinations of SCells 210 may achieve the larger BW. However, as described herein, the network entity 105-a may not be aware of which SCells 210 may be activated the quickest (e.g., which the least amount of latency), such that the network entity 105-a may indicate one or more SCells 210 to be activated based on the one or more SCells 210 enabling access to the larger BW. However, one or more other SCells may similarly enable access to the larger BW but with less latency in activation that the one or more SCells 210 indicated by the network entity 105-a.

Accordingly, techniques described herein may enable the UE 115-a to select one or more SCells 210 from the set of SCells 210 (e.g., configured SCells 210, candidate SCells 210) to activate based on one or more activation parameters (e.g., conditions) indicated by the network entity 105-a. That is, rather than the network entity 105-a transmitting a control message 215 indicating the one or more SCells 210 to be activated by the UE 115-a, the network entity 105-a may transmit one or more control messages 215 indicating a plurality of candidate SCells 210 and one or more activation parameters to be satisfied by an SCell activation, such that the UE 115-a may select one or more SCells 210 from the set of candidate SCells 210 to activate in accordance with (e.g., based on) the one or more parameters indicated by the network entity 105-a. Additionally, the UE 115-a may transmit, to the network entity 105-a in response to the selection, a report 220 indicating the one or more SCells 210 selected by the UE 115-a.

In such cases, the one or more activation parameters may include one or more of the following: a total quantity of SCells 210 (e.g., from the set of configured, but not already activated, SCells 210) to activate, a quantity of SCells 210 per frequency band, per frequency band combination, per frequency range, or any combination thereof, to activate, one or more frequency bands from which the one or more SCells 210 are to be activated, one or more threshold BWs (e.g., maximum BW, minimum BW, or both) to be supported per each SCell 210 to be activated, a total (e.g., cumulative) BW across all SCells 210 to be activated, or the like thereof. Additionally, or alternatively, the one or more activation parameters may include information related to a configuration of each SCell 210 to be activated, such as a total rank across all SCells 210 to be activated, a summation of BW times rank across all SCells 210 to be activated, or both. Additionally, or alternatively, the one or more activation parameters may include whether the one or more SCells 210 to be activated are to be in a primary PUCCH group or a secondary PUCCH group, a quantity of SCells 210 to activate for each PUCCH group (e.g., each of the primary PUCCH group and the secondary PUCCH group), a BW to activate for each PUCCH group, a quantity of SCells 210 to be activated in a first cell group (e.g., primary cell group, master cell group), a quantity of SCells 210 to be activated in a second cell group (e.g., secondary cell group), whether the one or more SCells 210 to be activated are in a same TAG as a reference cell (e.g., the network entity 105-a, a PCell, another SCell), or any combination thereof. Additionally, or alternatively, in the case that activation of one or more SCells 210 may occur separately for downlink operations and uplink operations, the one or more activation parameters may also indicate (e.g., request) whether the one or more SCells 210 are to be activated in downlink, uplink, or both.

For example, if the UE 115-a is configured with three SCells 210 (e.g., in FR2), as depicted in FIG. 2, and two SCells 210 (e.g., X SCells 210, where X<3) are capable of supporting one or more application bursts to be scheduled by the network entity 105-a (e.g., X×100 MHz), rather than the network entity 105-a indicating which two SCells 210 are to be activated by the UE 115-a, the network entity 105-a may indicate that a quantity of two SCells 210 are to be activated. In other words, rather than indicating two particular SCells 210 to be activated by the UE 115-a, the network entity 105-a may indicate that two SCells 210 are to be activated by the UE 115-a to support the one or more application bursts to be scheduled by the network entity 105-a. Thus, the UE 115-a may select which two SCells 210 from the three SCells 210 to activate. For example, the UE 115-a may select the SCell 210-a and the SCell 210-b based on a combination of the SCell 210-a and the SCell 210-b being associated with a lowest SCell activation latency out of all possible combinations of two SCells 210 from the set of SCells 210 (e.g., configured SCells 210) including the SCell 210-a, the SCell 210-b, and the SCell 210-c.

Additionally, or alternatively, the network entity 105-a may also indicate whether SCells 210 that are candidates for selection for activation, where the SCells may be selected from a set of known cells or unknown cells or the network entity 105-a may provide more one or more activation parameters may include one or more threshold metrics (e.g., detailed conditions for activation). For example, the one or more threshold metrics may include one or more SS RSRP thresholds, one or more SS RSRQ thresholds, one or more SS SINR thresholds, one or more SSB energy of the signal(Es), one or more SSB interference over thermal thresholds, one or more deactivated SCell measurement cycle (e.g., measurement cycle duration) thresholds, one or more deactivated SCell reporting cycle (e.g., reporting cycle duration) thresholds, or any combination thereof. In such cases (e.g., when the one or more activation parameters includes one or more threshold metrics), the UE 115-a may measure each SCell 210 of the set of SCells 210 to generate one or more respective metrics associated with each SCell 210 and may compare the one or more respective metrics to the one or more threshold metrics to identify whether each SCell 210 satisfies the one or more threshold metrics. If the one or more respective metrics associated with the SCell 210 satisfy the one or more threshold metrics, the SCell 210 may be a candidate SCell 210 that is available for selection by the UE 115-a. Conversely, if the one or more respective metrics associated with the SCell 210 fail to satisfy the one or more threshold metrics, the SCell 210 may not be available for selection by the UE 115-a.

In some cases, the one or more threshold metrics may correspond to whether an SCell 210 is a known SCell 210 or an unknown SCell 210. For example, a known SCell 210 may be an SCell 210 associated with one or more respective metrics that satisfy at least a subset of the one or more threshold metrics. Conversely, an unknown SCell 210 associated with one or more respective metrics that fail to satisfy at least the subset of the one or more threshold metrics. In some cases, instead of indicating the one or more threshold metrics, the UE 115-a may be pre-configured with the one or more threshold metrics such that the network entity 105-a may indicate whether the UE 115-a is to select one or more SCells 210 for activation from a set of known SCells 210 (e.g., from the set of SCells 210), from a set of unknown SCells 210 (e.g., from the set of SCells 210), or both. In some cases, the one or more threshold metrics may be independent from one or more other threshold metrics that correspond to whether an SCell 210 is a known SCell 210 or an unknown SCell 210 (e.g., to enable the network entity 105-a greater flexibility to select the one or more activation parameters). For example, an SCell 210 may be an unknown SCell 210 based on a measurement cycle or a reporting cycle of the SCell 210 exceeding a threshold measurement cycle or a threshold reporting cycle, respectively, however, the network entity 105-a may enable the UE 115-a to select the SCell 210 based on an RSRP or an SINR associated with the SCell 210 exceeding a threshold RSRP or threshold SINR, respectively (e.g., of the one or more threshold metrics).

In some cases, the UE 115-a may select the one or more SCells 210 to activate (e.g., in accordance with the one or more activation parameters) from the set of SCells 210 (e.g., from all of the configured, but not activated, SCells 210). In some other cases, the network entity 105-a may indicate a subset of the set of SCells 210 from which the UE 115-a is to select the one or more SCells 210 to activate. That is, a control message 215 (e.g., the same control message 215 as the control message 215 indicating the one or more activation parameters, or a different control message 215) may indicate the subset of the set of SCells 210 from which the UE 115-a may select the one or more SCells 210 to activate, and the UE 115-a may select the one or more SCells 210 to activate from the subset of the set of SCells 210 in accordance with the one or more activation parameters. In other words, the set of SCells 210 from which the UE 115-a may select the one or more SCells 210 may be the subset of the set of SCells 210 indicated by the network entity 105-a.

Additionally, or alternatively, the one or more activation parameters may include one or more restrictions (e.g., on the set of SCells 210). For example, the network entity 105-a may indicate for the UE 115-a to select X SCells 210 from the set of SCells 210 but may restrict the UE 115-a to selecting a top-X SCells 210 in terms of RSRP, SINR, or the like thereof (e.g., in terms of the one or more metrics). For example, the network entity 105-a may indicate to the UE 115-a to activate two SCells 210 from the three SCells 210 configured, but not yet activated, for the UE 115-a, including the SCell 210-a, the SCell 210-b, and the SCell 210-c, and that the two SCells 210 are to be associated with RSRPs exceeding a threshold RSRP. However, all of the SCell 210-a, the SCell 210-b, and the SCell 210-c may be associated with respective RSRPs exceeding the threshold RSRP. Thus, the UE 115-a may select two SCells 210, from the set of SCells 210, that have a highest RSRP and a second highest RSRP. For example, the SCell 210-a may be associated with a first RSRP, the SCell 210-b may be associated with a second RSRP, and the SCell 210-c may be associated with a third RSRP, where the first RSRP, the second RSRP, and the third RSRP satisfy the threshold RSRP. Thus, the UE 115-a may select the SCell 210-a and the SCell 210-b based on the first RSRP being the highest RSRP out of the first RSRP, the second RSRP, and the third RSRP, and the second RSRP being second highest out of the first RSRP, the second RSRP, and the third RSRP. In other example, the network entity 105-a may indicate for the UE 115-a to select X SCells 210 from the set of SCells 210 but may restrict the UE 115-a to selecting a top-X SCells 210 in terms of measurement cycle duration, reporting cycle duration, or both.

In some examples, the UE 115-a may not be capable of activating enough SCells 210 (e.g., a sufficient quantities of SCells 210), from the set of SCells 210, that meet the one or more activation parameters indicated by the network entity 105-a. For example, the network entity 105-a may indicate for the UE 115-a to activate three SCells 210 with respective RSRPs exceeding a threshold RSRP, however, out of the set of SCells 210 configured for the UE 115-a, two SCells 210 may be associated with respective RSRPs exceeding (e.g., satisfying) the threshold RSRP and the remaining SCells 210 may be associated with respective RSRPs failing to exceed the threshold RSRP. In such cases, the UE 115-a may activate one or more SCells 210 in accordance with one or more options.

According to a first option, the UE 115-a may activate as many SCells 210, from the set of SCells 210, satisfying the one or more activation parameters as possible and may transmit, via the report 220, an indication that the UE 115-a was not capable of activating enough SCells 210, from the set of SCells 210, that meet the one or more activation parameters. In some cases, the report 220 may additionally, or alternatively, indicate which activation parameters of the one or more activation parameters caused the UE 115-a to fail to activate enough SCells 210. In other words, the report 220 may indicate which activation parameters of the one or more activation parameters cannot be satisfied by one or more additional SCells 210 (e.g., from the set of SCells 210). By indicating that the UE 115-a was not capable of activating enough SCells 210, the described techniques may enable the network entity 105-a to adjust subsequent communications in accordance with what quantity of SCells 210 were activated, thus improving communication performance by avoiding over-scheduling the UE 115-a.

According to a second option, the UE 115-a may activate as many SCells 210, from the set of SCells 205, satisfying the one or more activation parameters as possible and may further activate one or more other SCells 210 that do not satisfy the one or more activation parameters. In such cases, the UE 115-a may transmit, via the report 220, an indication of which SCells 210 of the one or more SCells 210 activated by the UE 115-a do not satisfy the one or more activation parameters (e.g., indicate that the one or more other SCells 210 do not satisfy the one or more activation parameters. By activating one or more other SCells 210 that do not satisfy the one or more activation parameters, the described techniques may enable the UE 115-a to activate a sufficient quantity of SCells 210 to support subsequent communications by the network entity 105-a, thus reducing latency (e.g., due to decreased scheduling if only SCells 210, satisfying the one or more activation parameters were activated).

According to a third option, the UE 115-a may activate as many SCells 210 satisfying the one or more activation parameters as possible and may further activate one or more other SCells 210 that do not satisfy the one or more activation parameters, where the one or more other SCells 210 satisfy the one or more activation parameters in accordance with one or more tolerances. That is, the network entity 105-a may indicate, to the UE 115-a (e.g., via a control message 215, via the control message 215 indicative of the one or more activation parameters) one or more tolerances (e.g., relaxation factors) associated with the one or more activation parameters. Thus, the UE 115-a may select one or more first SCells 210 to activate in accordance with the one or more activation parameters (e.g., without the one or more tolerances applied) and, if a first quantity of the one or more first SCells 210 is less than a second quantity of SCells 210 corresponding to satisfaction of the one or more activation parameters, the UE 115-a may select one or more second SCells 210 to active in accordance with the one or more activation parameters adjusted in accordance with the one or more tolerances (e.g., the one or more activation parameters with the one or more tolerances applied). By activating one or more other SCells 210 that do not satisfy the one or more activation parameters, where the one or more other SCells 210 satisfy the one or more activation parameters in accordance with one or more tolerances, the described techniques may enable the UE 115-a to activate a sufficient quantity of SCells 210 to support subsequent communications by the network entity 105-a, thus reducing latency (e.g., due to decreased scheduling if only SCells 210, satisfying the one or more activation parameters were activated).

In some cases, the first quantity of the one or more first SCells 210 and a third quantity of the one or more second SCells 210 may be equal to the second quantity of SCells 210 corresponding to satisfaction of the one or more activation parameters (e.g., the first quantity of the one or more first SCells 210 plus the third quantity of the one or more second SCells 210 may be sufficient), such that the UE 115-a may not (e.g., does not need to) activate more SCells 210. Conversely, in some cases, the first quantity of the one or more first SCells 210 and the third quantity of the one or more second SCells 210 may be less than the second quantity of SCells 210 corresponding to satisfaction of the one or more activation parameters (e.g., the first quantity of the one or more first SCells 210 plus the third quantity of the one or more second SCells 210 may be insufficient). In such cases, the UE 115-a may refrain from activating one or more other SCells 210 (e.g., the UE 115-a may activate a quantity of SCells 210 less than a quantity of SCells 210 intended by the network entity 105-a).

In some cases, the network entity 105-a may indicate which option or options of the first option, the second option, the third option, or any combination thereof, is to be applied by the UE 115-a when the UE 115-a is not be capable of activating enough SCells 210, from the set of SCells 210, that meet the one or more activation parameters indicated by the network entity 105-a. In some cases, the network entity 105-a may indicate one of the first option, the second option, the third option, or any combination thereof via the control message 215 indicating the one or more activation parameters. Additionally, or alternatively, the network entity 105-a may indicate one of the first option, the second option, the third option, or any combination thereof via RRC signaling (e.g., RRC configuration).

Additionally, or alternatively, the report 220 may include an indication of a set of SCells 210 (e.g., a list of SCells 210) that are activated (e.g., currently activated). For example, the report 220 may indicate a corresponding cell index for each activated SCell 210. In some cases, the UE 115-a may transmit the report 220 to the network entity 105-a (e.g., the PCell, the already activated SCell 210), any SCell 210 already activated for the UE 115-a (e.g., prior to the transmission of the report 220, prior to the determination of the one or more SCells 210 to be activated by the UE 115-a), or both. Additionally, or alternatively, the UE 115-a may transmit the report 220 via a PUSCH, a PUCCH, or both.

In some cases, the network entity 105-a may indicate, via a control message 215, the one or more activation parameters and may indicate (e.g., explicitly), via the control message 215, one or more SCells 210 to be activated by the UE 115-a. That is, the control message 215 may indicate a first subset of SCells 210 (e.g., from the set of SCells 210) to be activated by the UE 115-a and the one or more activation parameters to be used by the UE 115-a to select a second subset of SCells 210 (e.g., from the set of SCells 210), where the first subset is different than the second subset. For example, the control message 215 may indicate for the UE 115-a to activate the SCell 210-a and to activate one of the SCell 210-b and the SCell 210-c in accordance with the one or more activation parameters, where the control message 215 indicates the one or more activation parameters.

In some cases, the network entity 105-a may indicate for the UE 115-a to activate the SCell 210-a based on the SCell 210-a being of a second PUCCH group. In another example, one or more SCells 210 to be activated by the UE 115-a (e.g., based on the one or more activation parameters) may be based on whether transmission configuration indicator (TCI) state activation for the one or more SCells 210 is also received with the control message 215 (e.g., an activation comment) or not. That is, if the control message 215 indicating the one or more activation parameters also indicates one or more TCI state activations, the UE 115-a may activate one or more corresponding SCells 210. Conversely, if the control message 215 does not indicate the one or more TCI state activations, the UE 115-a may select the one or more SCells 210 to activate in accordance with the one or more activation parameters. In other words, rather than explicitly indicating the first subset of SCells 210 to be activated by the UE 115-a, the network entity 105-a may indicate (e.g., via the control message 215, via the activation command) one or more TCI states corresponding to the first subset of SCells 210.

In some cases, a subset of SCells 210 from which the UE 115-a is to activate one or more SCells 210 in accordance with the one or more activation parameters may be indicated via one or more same control messages 215 as the indication of the one or more activation parameters, via one or more different control messages 215, or both. In some examples, the one or more same control messages 215 may include an activation DCI message, an activation MAC-CE message, or both. Additionally, or alternatively, the one or more different control messages 215 may include another (e.g., separate) DCI message, another MAC-CE message, or both. For example, the network entity 105-amay indicate the one or more activation parameters via an RRC message (e.g., as part of an SCell configuration, or via a separate RRC message that applies to multiple SCells 210) and may indicate the subset of SCells 210 from which the UE 115-a is to activate the one or more SCells 210 via a DCI message or a MAC-CE message.

In some cases, the UE 115-a may perform SCell deactivation in accordance with the techniques described herein. That is, the network entity 105-a may transmit one or more control messages 215 indicating one or more deactivation parameters, one or more SCells 210 to deactivate, or both. As such, the UE 115-a may deactivate one or more SCells 210 (e.g., from a set of activated SCells 210) based on selection of the one or more SCells 210 in accordance with the one or more deactivation parameters, based on the one or more SCells 210 indicated via the one or more control messages 215, or both. In such cases, the one or more deactivation parameters may be the same as or similar to the one or more activation parameters, as described herein.

Additionally, or alternatively, the UE 115-a may transmit a capability message indicating one or more capabilities of the UE 115-a to select one or more SCells 210 in accordance with one or more activation parameters. Thus, SCell activation, as described herein, may be in accordance with the one or more capabilities of the UE 115-a. In such cases, the UE 115-a may report the one or more capabilities in accordance with one or more different granularities, such as per UE 115, per band, per band combination, per uplink feature set, per downlink feature set, or any combination thereof.

Additionally, or alternatively, the UE 115-a may select one or more SCells 210 to activate in accordance with one or more activation parameters based on one or more conditions associated with the UE 115-a, where the one or more conditions may include at least one or one or more latency thresholds associated with the UE 115-a, a power level associated with the UE 115-a, one or one or more communication quality (e.g., performance) thresholds associated with the UE 115-a, one or more throughput thresholds, or the like thereof. In other words, the UE 115-a may select one or more SCells 210 to activate in accordance with one or more activation parameters and in accordance with the one or more conditions associated with the UE 115-a. For example, the UE 115-a may select the one or more SCells 210 (e.g., in accordance with the one or more activation parameters) based on the one or more SCells 210 being capable of being activated the fastest, the one or more SCells 210 being associated with a lowest power consumption, the one or more SCells 210 being associated with a highest communication quality, the one or more SCells 210 being associated with a highest throughput, or any combination thereof (e.g., out of a set of SCells 210 satisfying the one or more activation parameters). In some examples, the network entity 105-a may indicate, to the UE 115-a (e.g., via a control message 215) which of the one or more conditions associated with the UE 115-a are to be considered by (e.g., used by) the UE 115-a during selection of the one or more SCells 210).

Each SCell 210 may be associated with one or more component carriers (CCs), such that selecting one or more SCells 210 based on one or more activation parameters may be synonymous to selecting one or more CCs based on the one or more activation parameters. As such, the terms “SCell 210” and “CCs,” as used herein, are interchangeable.

Additionally, or alternatively, the techniques described herein may be applicable to a single cell (e.g., virtual cell) with multiple CCs, multiple sub-bands, or both. That is, the cell may transmit, to the UE 115-a, a first control message 215 indicating the multiple CCs, the multiple sub-bands, or both, and may transmit a second control message 215 (e.g., the same or different than the first control message 215) indicating one or more activation parameters associated with CC activation, sub-band activation, or both. Thus, the UE may select one or more CCs from the multiple CCs, one or more sub-bands from the multiple sub-bands, or both, in accordance with the one or more activation parameters and may report the one or more CCs, the one or more sub-bands, or both, prior to (e.g., or before, or simultaneously with) activation of the one or more CCs, the one or more sub-bands, or both.

As described herein, techniques for selecting one or more SCells 210 for activation in accordance with one or more activation parameters may result in reduced processing, reduced power consumption, and more efficient utilization of communication resources, among other advantages.

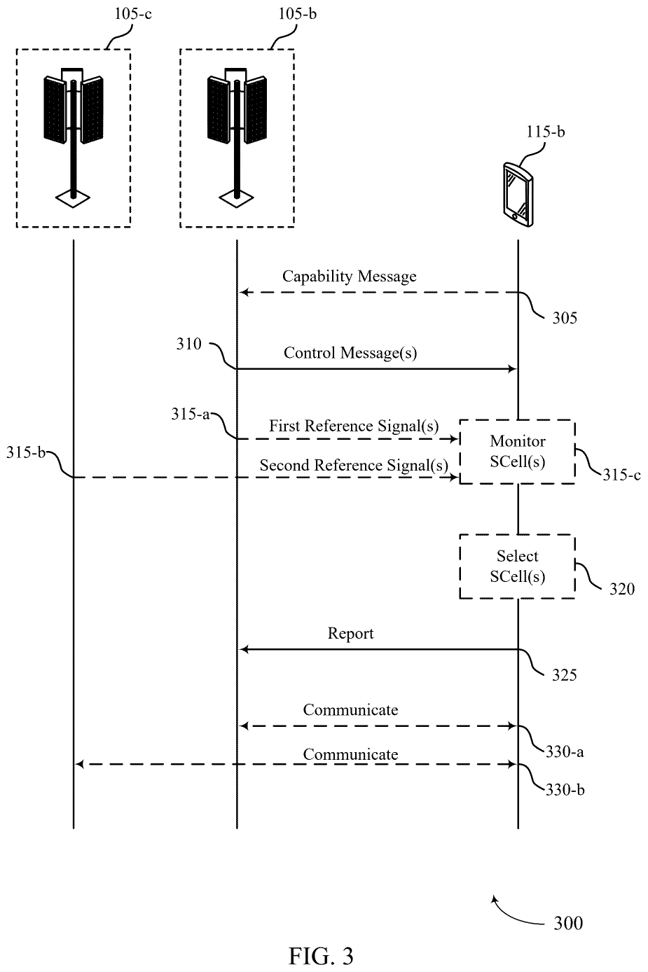

FIG. 3 shows an example of a process flow 300 that supports techniques for SCell activation in accordance with one or more aspects of the present disclosure. In some cases, the process flow 300 may implement or be implemented by aspects of the wireless communications system 100, the wireless communications system 200, or both. For example, the process flow 300 may include one or more UEs 115 (e.g., a UE 115-b) and one or more network entities 105 (e.g., a network entity 105-b and one or more network entities 105-c), which may be examples of the corresponding devices as described herein. In the following description of the process flow 300, the operations between the UE 115-b and the network entity 105-b may be communicated in a different order than the example order shown, or the operations performed by the UE 115-b and the network entity 105-b may be performed in different orders or at different times. Some operations may also be omitted from the process flow 300, and other operations may be added to the process flow 300.

In some cases, at 305, the UE 115-b may transmit a capability message indicative of one or more capabilities of the UE 115-b to select, in accordance with one or more activation parameters, one or more SCells from a set of SCells configured, but not yet activated, for the UE 115-b. In some cases, the set of SCells may be associated with a network entity 105-c.

At 310, the UE 115-b may receive, from the network entity 105-b, which may be associated with a PCell or an activated SCell, one or more control messages indicative of the set of SCells and indicative of the one or more activation parameters.

In some cases, the one or more activation parameters may include one or more threshold metrics, such one or more RSRP threshold, one or more RSRQ thresholds, one or more Es thresholds, one or more interference over thermal thresholds, one or more threshold durations associated with a measurement cycle, one or more threshold durations associated with a reporting cycle, or any combination thereof.

Additionally, or alternatively, the one or more activation parameters may include a quantity of the one or more SCells to be activated, a quantity of SCells to be activated per frequency band, per frequency band combination, per frequency range, or any combination thereof, one or more frequency bands associated with the one or more SCells to be activated, one or more threshold BWs per SCell of the one or more SCells to be activated, a total BW across the one or more SCells to be activated, one or more configuration parameters associated with the one or more SCells to be activated, one or more transmission directions associated with activation of the one or more SCells, a quantity of the one or more SCells to be activated in a primary PUCCH group, a quantity of the one or more SCells to be activated in a secondary PUCCH group, or any combination thereof.

In some cases, the one or more control messages may include an activation DCI message, an activation MAC-CE message, one or more other DCI messages different than the activation DCI message, one or more other MAC-CE messages different than the activation MAC-CE message, one or more RRC messages, or any combination thereof.

In some cases, at 315-a, the network entity 105-b may transmit one or more first more reference signals, at 315-b, the set of SCells may transmit one or more second more reference signals, or both, such that, at 315-c, the UE 115-b may monitor the network entity 105-b, each of the SCells, or both, (e.g., may measure the one or more first reference signals, the one or more second reference signals, or both) to generate one or more respective metrics associated with each network entity 105.

In some cases, at 320, the UE 115-b may select the one or more SCells, from the set of SCells, to be activated in accordance with the one or more activation parameters. In some cases, the selection of the one or more SCells may be based on one or more respective metrics associated with each SCell of the one or more SCells satisfying the one or more threshold metrics. Additionally, selection of the one or more SCells from the set of SCells may be in accordance with the one or more respective metrics being greatest out of the set of SCells.

Additionally, or alternatively, the UE 115-b may select the one or more SCells from the set of SCells in accordance with the one or more activation parameters and may select one or more additional SCells from the set of SCells based on a second quantity of the one or more SCells satisfying the one or more activation parameters being less than a first quantity of SCells corresponding to the one or more activation parameters. In such cases, the one or more additional SCells may fail to satisfy the one or more activation parameters. However, in some cases, the one or more additional SCells may satisfy the one or more application parameters in accordance with one or more tolerances (e.g., based on one or more tolerances being applied to the one or more application parameters), where the one or more control messages indicate the one or more tolerances.

Additionally, or alternatively, the UE 115-b may select the one or more SCells from the set of SCells in accordance with one or more conditions associated with the UE 115-b, where the one or more conditions include a latency threshold associated with activation of the one or more SCells, a power level of the UE, a threshold quality associated with activation of the one or more SCells, or any combination thereof. Additionally, or alternatively, the UE 115-b may select the one or more SCells from a subset of the set of SCells in accordance with the one or more control messages indicating the subset of the set of SCells from which the UE 115-b is to select the one or more SCells.

Thus, at 325, the UE 115-a may transmit a report indicative of activation of the one or more SCells, from the set of SCells, to be activated based on selection of the one or more SCells from the set of SCells in accordance with the one or more activation parameters.

In some cases, the one or more activation parameters may correspond to activation of the first quantity of SCells, where the second quantity of the one or more SCells satisfying the one or more activation parameters may be less than the first quantity of SCells, such that the report is indicative of at least a subset of the one or more activation parameters that prevent activation of the first quantity of SCells.

In some cases, at 330-b, the UE 115-b may communicate one or more messages with the one or more activated SCells based on transmission of the report. Additionally, at 330-a, the UE 115-b may communicate one or more messages with the network entity 105-b based on the network entity 105-b already being activated. Additionally, the UE 115-b may communicate one or more additional messages with one or more other SCells (e.g., a first subset of SCells) from the set of SCells based on the one or more control messages indicating (e.g., explicitly) that the one or more other SCells are to be activated by the UE 115-b.

In some cases, the PCell or the activated SCell and the set of SCells may be associated with a same network. In other words, the network entity 105-b and the network entity 105-c may be a same network entity 105 that operates both the PCell or the activated SCell and the set of SCells. In such cases, communicating the one or more messages with the one or more activated SCells may include communicating the one or more messages with the same network entity 105 via the one or more SCells activated by the UE 115-b. In some other cases, the PCell or the activated SCell and the set of SCells may be associated with different networks. In other words, the network entity 105-b and the network entity 105-c may be different network entities 105, where the network entity 105-b operates the PCell or the activated SCell and the network entity 105-c operates the set of SCells. In such cases, communicating the one or more messages with the one or more activated SCells may include communicating the one or more messages with the network entity 105-c via the one or more SCells from the set of SCells, where the network entity 105-c is different than the network entity 105-b.

Additionally, or alternatively, (e.g., not depicted), the one or more SCells activated by the UE 115-b may be associated with at least two different networks. For example, a first subset of the one or more SCells selected by the UE 115-b may be associated with the network entity 105-c and a second subset of the one or more SCells selected by the UE 115-b may be associated with a network entity 105-d (e.g., not depicted), where the network entity 105-c is different than the network entity 105-d. In other words, the network entity 105-c may operate the first subset of the one or more SCells selected by the UE 115-b and the network entity 105-d may operate the second subset of the one or more SCells selected by the UE 115-b. In such cases, communicating the one or more messages with the one or more activated SCells may include communicating the one or more messages with the network entity 105-c via the first subset of the one or more SCells activated by the UE 115-b and with the network entity 105-d via the second subset of the one or more SCells activated by the UE 115-b. In some examples, one of the network entity 105-c or the network entity 105-d may be the same as the network entity 105-b, as described herein.

In some cases, at a later time, the UE 115-b may receive, from the network entity 105-b, one or more second control messages indicative of one or more deactivation parameters associated with SCell deactivation and may transmit a second report indicative of deactivation of at least a subset of the one or more SCells based on selection of the subset from the one or more SCells in accordance with the one or more deactivation parameters.

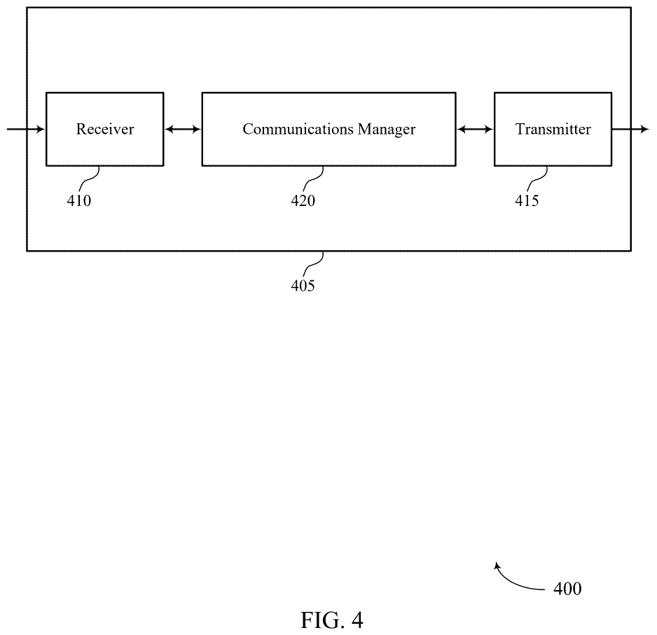

FIG. 4 shows a block diagram 400 of a device 405 that supports techniques for SCell activation in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to techniques for SCell activation). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to techniques for SCell activation). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of techniques for SCell activation as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for receiving one or more control messages indicative of a set of multiple SCells and indicative of one or more activation parameters associated with SCell activation. The communications manager 420 is capable of, configured to, or operable to support a means for transmitting a report indicative of activation of one or more SCells of the set of multiple SCells based on selection of the one or more SCells from the set of multiple SCells in accordance with the one or more activation parameters.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for selecting one or more SCells for activation in accordance with one or more activation parameters, which may result in reduced processing, reduced power consumption, and more efficient utilization of communication resources, among other advantages.

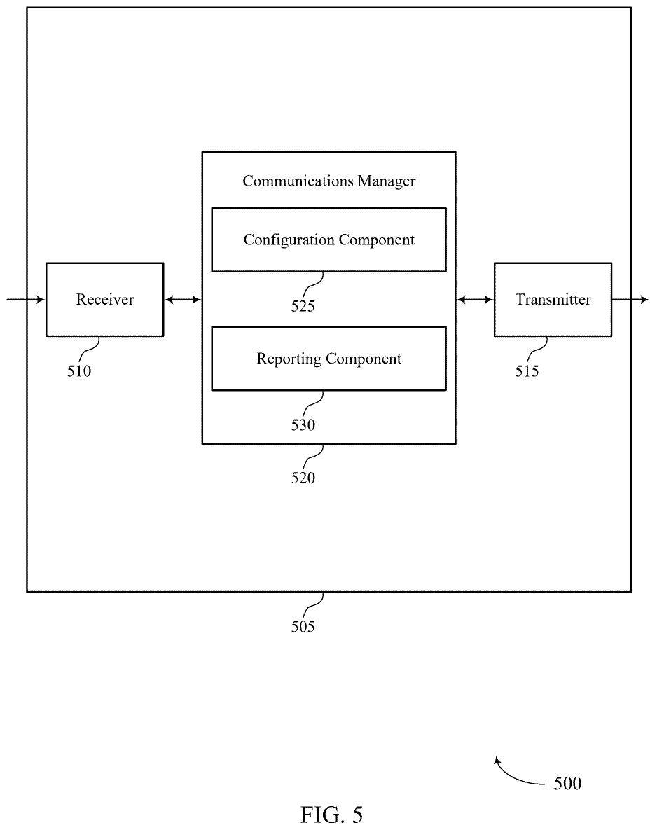

FIG. 5 shows a block diagram 500 of a device 505 that supports techniques for SCell activation in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for SCell activation). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for SCell activation). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of techniques for SCell activation as described herein. For example, the communications manager 520 may include a configuration component 525, a reporting component 530, or both. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The configuration component 525 is capable of, configured to, or operable to support a means for receiving one or more control messages indicative of a set of multiple SCells and indicative of one or more activation parameters associated with SCell activation. The reporting component 530 is capable of, configured to, or operable to support a means for transmitting a report indicative of activation of one or more SCells of the set of multiple SCells based on selection of the one or more SCells from the set of multiple SCells in accordance with the one or more activation parameters.

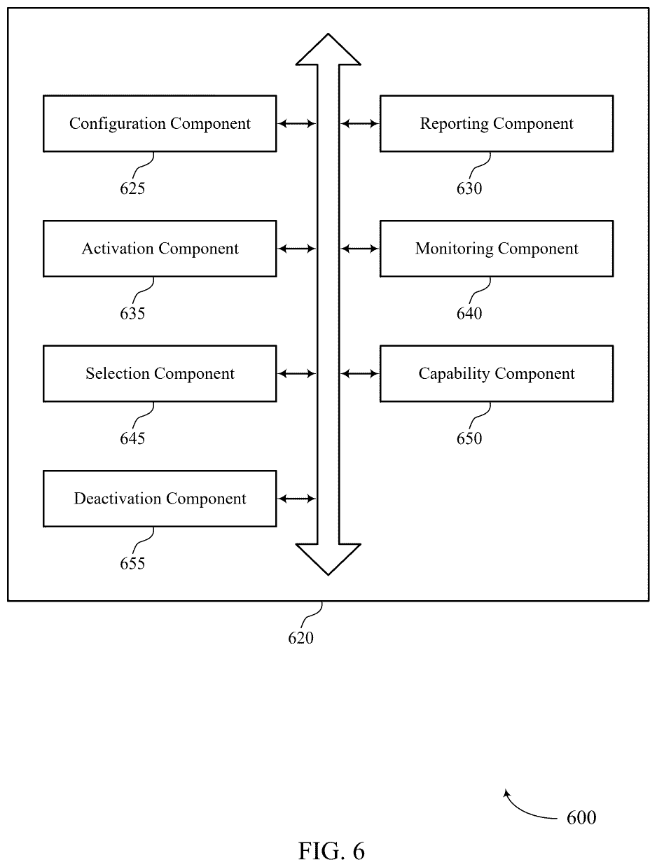

FIG. 6 shows a block diagram 600 of a communications manager 620 that supports techniques for SCell activation in accordance with one or more aspects of the present disclosure. The communications manager 620 may be an example of aspects of a communications manager 420, a communications manager 520, or both, as described herein. The communications manager 620, or various components thereof, may be an example of means for performing various aspects of techniques for SCell activation as described herein. For example, the communications manager 620 may include a configuration component 625, a reporting component 630, an activation component 635, a monitoring component 640, a selection component 645, a capability component 650, a deactivation component 655, or any combination thereof. Each of these components, or components or subcomponents thereof (e.g., one or more processors, one or more memories), may communicate, directly or indirectly, with one another (e.g., via one or more buses).

The communications manager 620 may support wireless communications in accordance with examples as disclosed herein. The configuration component 625 is capable of, configured to, or operable to support a means for receiving one or more control messages indicative of a set of multiple SCells and indicative of one or more activation parameters associated with SCell activation. The reporting component 630 is capable of, configured to, or operable to support a means for transmitting a report indicative of activation of one or more SCells of the set of multiple SCells based on selection of the one or more SCells from the set of multiple SCells in accordance with the one or more activation parameters.

In some examples, the activation component 635 is capable of, configured to, or operable to support a means for communicating one or more messages with the one or more SCells based on transmission of the report.

In some examples, the one or more activation parameters include one or more threshold metrics, and the monitoring component 640 is capable of, configured to, or operable to support a means for monitoring the set of multiple SCells to generate one or more respective metrics associated with each SCell of the set of multiple SCells. In some examples, the one or more activation parameters include one or more threshold metrics, and the selection component 645 is capable of, configured to, or operable to support a means for selecting the one or more SCells from the set of multiple SCells based on one or more respective metrics associated with each SCell of the one or more SCells satisfying the one or more threshold metrics.

In some examples, the one or more respective metrics include an RSRP, an RSRQ, an SINR, an Eₛ, an interference over thermal, a duration of a measurement cycle, a duration of a reporting cycle, or any combination thereof.

In some examples, selection of the one or more SCells from the set of multiple SCells is in accordance with the one or more respective metrics associated with each SCell of the one or more SCells being greatest out of the set of multiple SCells.

In some examples, the one or more activation parameters correspond to activation of a first quantity of SCells. In some examples, a second quantity of the one or more SCells satisfying the one or more activation parameters is less than the first quantity of SCells. In some examples, the report is indicative of at least a subset of the one or more activation parameters that prevent activation of the first quantity of SCells.

In some examples, the one or more activation parameters correspond to activation of a first quantity of SCells, and the selection component 645 is capable of, configured to, or operable to support a means for selecting the one or more SCells from the set of multiple SCells in accordance with the one or more activation parameters. In some examples, the one or more activation parameters correspond to activation of a first quantity of SCells, and the selection component 645 is capable of, configured to, or operable to support a means for selecting one or more additional SCells for the set of multiple SCells, where the one or more additional SCells fail to satisfy the one or more activation parameters, and where the report indicates that the one or more additional SCells fail to satisfy the one or more activation parameters.

In some examples, the one or more control messages indicate one or more tolerances associated with the one or more activation parameters. In some examples, the one or more SCells satisfy the one or more activation parameters in accordance with the one or more tolerances.

In some examples, the capability component 650 is capable of, configured to, or operable to support a means for transmitting a capability message indicative of a capability of the UE to select the one or more SCells from the set of multiple SCells in accordance with the one or more activation parameters, where reception of the one or more control messages is based on transmission of the capability message.

In some examples, the configuration component 625 is capable of, configured to, or operable to support a means for receiving one or more second control messages indicative of one or more deactivation parameters associated with SCell deactivation. In some examples, the deactivation component 655 is capable of, configured to, or operable to support a means for transmitting a second report indicative of deactivation of at least a subset of the one or more SCells based on selection of the subset from the one or more SCells in accordance with the one or more deactivation parameters.

In some examples, the selection component 645 is capable of, configured to, or operable to support a means for selecting the one or more SCells from the set of multiple SCells in accordance with one or more conditions associated with the UE, where the one or more conditions include a latency threshold associated with activation of the one or more SCells, a power level of the UE, a threshold quality associated with activation of the one or more SCells, or any combination thereof.

In some examples, the one or more control messages indicate a first subset of secondary cells from the plurality of secondary cells to be activated by the UE and selection of the one or more secondary cells is from a remaining subset of secondary cells from the set of multiple secondary cells based at least in part on the indication of the first subset of secondary cells. In such cases, the activation component 635 is capable of, configured to, or operable to support a means for communicating the one or more messages with the one or more SCells based on transmission of the report and with the first subset of SCells based on the indication of the first subset of SCells.

In some examples, the one or more activation parameters includes a quantity of the one or more SCells to be activated, a quantity of SCells to be activated per frequency band, per frequency band combination, per frequency range, or any combination thereof, one or more frequency bands associated with the one or more SCells to be activated, one or more threshold BWs per SCell of the one or more SCells to be activated, a total BW across the one or more SCells to be activated, one or more configuration parameters associated with the one or more SCells to be activated, one or more transmission directions associated with activation of the one or more SCells, a quantity of the one or more SCells to be activated in a primary uplink control group, a quantity of the one or more SCells to be activated in a secondary uplink control group, a quantity of the one or more secondary cells to be activated in a first cell group, a quantity of the one or more secondary cells to be activated in a second cell group, or any combination thereof.

In some examples, the one or more control messages indicate a subset of SCells from the set of multiple SCells. In some examples, selection of the one or more SCells is from the subset of SCells.

In some examples, the one or more control messages include an activation DCI message, an activation MAC-CE message, an additional DCI message different than the activation DCI message, an additional MAC-CE message different than the activation MAC-CE message, a radio resource control message, or any combination thereof.

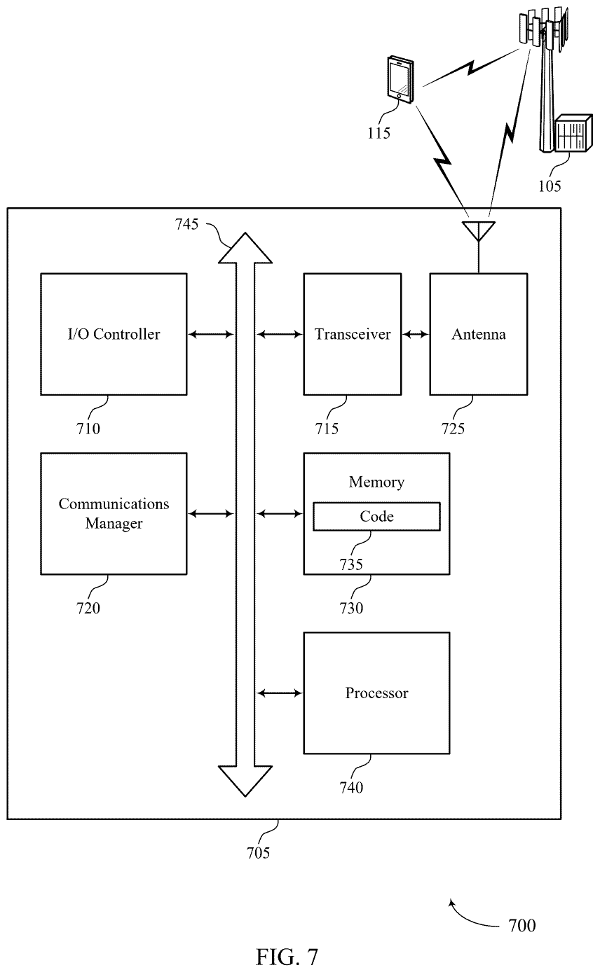

FIG. 7 shows a diagram of a system 700 including a device 705 that supports techniques for SCell activation in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting techniques for SCell activation). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The communications manager 720 may support wireless communications in accordance with examples as disclosed herein. For example, the communications manager 720 is capable of, configured to, or operable to support a means for receiving one or more control messages indicative of a set of multiple SCells and indicative of one or more activation parameters associated with SCell activation. The communications manager 720 is capable of, configured to, or operable to support a means for transmitting a report indicative of activation of one or more SCells of the set of multiple SCells based on selection of the one or more SCells from the set of multiple SCells in accordance with the one or more activation parameters.

By including or configuring the communications manager 720 in accordance with examples as described herein, the device 705 may support techniques selecting one or more SCells for activation in accordance with one or more activation parameters.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of techniques for SCell activation as described herein, or the at least one processor 740 and the at least one memory 730 may be otherwise configured to, individually or collectively, perform or support such operations.

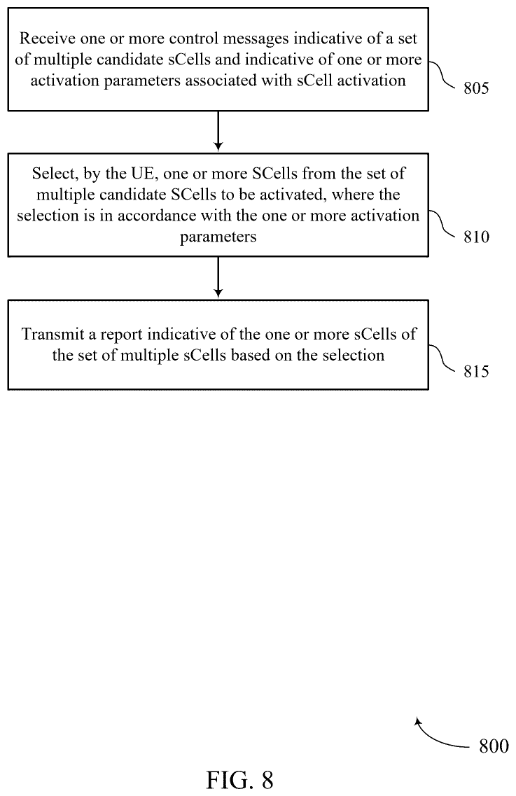

FIG. 8 shows a flowchart illustrating a method 800 that supports techniques for SCell activation in accordance with one or more aspects of the present disclosure. The operations of the method 800 may be implemented by a UE or its components as described herein. For example, the operations of the method 800 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 805, the method may include receiving one or more control messages indicative of a set of multiple candidate SCells and indicative of one or more activation parameters associated with SCell activation. The operations of 805 may be performed in accordance with examples as disclosed herein. In some examples, aspects of the operations of 805 may be performed by a configuration component 625 as described with reference to FIG. 6.

At 810, the method may include selecting, by the UE, one or more SCells from the set of multiple candidate SCells to be activated, where the selection is in accordance with the one or more activation parameters. The operations of 810 may be performed in accordance with examples as disclosed herein. In some examples, aspects of the operations of 810 may be performed by a selection component 645 as described with reference to FIG. 6.

At 815, the method may include transmitting a report indicative of the one or more SCells of the set of multiple candidate SCells based on the selection. The operations of 815 may be performed in accordance with examples as disclosed herein. In some examples, aspects of the operations of 815 may be performed by a reporting component 630 as described with reference to FIG. 6.

The following provides an overview of aspects of the present disclosure:

Aspect 1: A method for wireless communications at a UE, comprising: receiving one or more control messages indicative of a plurality of candidate SCells and indicative of one or more activation parameters associated with secondary cell activation; selecting, by the UE, one or more secondary cells from the plurality of candidate secondary cells to be activated, wherein the selection is in accordance with the one or more activation parameters; and transmitting a report indicative of the one or more SCells of the plurality of candidate SCells based at least in part on the selection.

Aspect 2: The method of aspect 1, wherein the one or more activation parameters comprise one or more threshold metrics, the method further comprising: monitoring the plurality of candidate SCells to generate one or more respective metrics associated with each secondary cell of the plurality of candidate SCells; and selecting the one or more SCells from the plurality of candidate SCells based at least in part on one or more respective metrics associated with each secondary cell of the one or more SCells satisfying the one or more threshold metrics.

Aspect 3: The method of aspect 2, wherein the one or more metrics comprise a reference signal received power, a reference signal received quality, a signal-to-interference and noise ratio, an energy of a signal, an interference over thermal, a duration of a measurement cycle, a duration of a reporting cycle, or any combination thereof.

Aspect 4: The method of any of aspects 2 through 3, wherein selection of the one or more SCells from the plurality of candidate SCells is in accordance with the one or more respective metrics associated with each secondary cell of the one or more SCells satisfying the one or more threshold metrics and being the greatest out of the plurality of candidate SCells.

Aspect 5: The method of any of aspects 1 through 4, wherein a first activation parameter of the one or more activation parameters indicates that a second quantity of secondary cells from the plurality of candidate secondary cells are to be activated by the UE, and wherein selecting the one or more secondary cells comprises: selecting a first quantity of secondary cells of the plurality of candidate secondary cells to be activated in accordance with each secondary cell of the first quantity of secondary cells satisfying a second activation parameter of the one or more activation parameters, wherein the first quantity of secondary cells is less than the second quantity of secondary cells, and wherein the report is indicative of the second activation parameter in accordance with the first quantity of secondary cells being less than the second quantity of secondary cells.

Aspect 6: The method of any of aspects 1 through 5, wherein the one or more activation parameters correspond to activation of a first quantity of SCells, wherein a second quantity of the one or more SCells is less than the first quantity of SCells, and wherein the method further comprises: selecting the one or more SCells from the plurality of candidate SCells in accordance with the one or more activation parameters; and selecting one or more additional SCells for the plurality of candidate SCells, wherein the one or more additional SCells fail to satisfy the one or more activation parameters, wherein the one or more secondary cells and the one or more additional secondary cells, in combination, comprise the first quantity of secondary cells, and wherein the report indicates that the one or more additional SCells fail to satisfy the one or more activation parameters.

Aspect 7: The method of aspect 6, wherein the one or more control messages indicate one or more tolerances associated with the one or more activation parameters, and wherein the method further comprises: selecting a first subset of the one or more secondary cells from the plurality of candidate secondary cells in accordance with the first subset of the one or more secondary cells satisfying the one or more activation parameters; and selecting a second subset of the one or more secondary cells from the plurality of candidate secondary cells in accordance with the second subset of the one or more secondary cells satisfy the one or more activation parameters in accordance with the one or more tolerances.

Aspect 8: The method of any of aspects 1 through 7, further comprising: transmitting a capability message indicative of a capability of the UE to select the one or more SCells from the plurality of candidate SCells in accordance with the one or more activation parameters, wherein reception of the one or more control messages is based at least in part on transmission of the capability message.

Aspect 9: The method of any of aspects 1 through 8, further comprising: receiving, from the primary cell, one or more second control messages indicative of one or more deactivation parameters associated with secondary cell deactivation; and transmitting a second report indicative of deactivation of at least a subset of the one or more SCells that were activated based at least in part on selection of the subset from the one or more SCells in accordance with the one or more deactivation parameters.

Aspect 10: The method of any of aspects 1 through 9, further comprising: selecting the one or more SCells from the plurality of candidate SCells in accordance with the one or more activation parameters and in accordance with one or more conditions associated with the UE, wherein the one or more conditions comprise a latency threshold associated with activation of the one or more SCells, a power level of the UE, a threshold quality associated with activation of the one or more SCells, or any combination thereof.

Aspect 11: The method of any of aspects 1 through 10, wherein the one or more control messages indicate a first subset of SCells from the plurality of candidate SCells to be activated by the UE, wherein selection of the one or more SCells is from a remaining subset of SCells from the plurality of candidate SCells based at least in part on reception of the indication of the first subset of SCells, and wherein communicating the one or more messages with the one or more SCells further comprises: communicating the one or more messages with the one or more SCells based at least in part on transmission of the report and with the first subset of SCells based at least in part on the indication of the first subset of SCells.

Aspect 12: The method of any of aspects 1 through 11, wherein the one or more activation parameters comprises a quantity of the one or more SCells to be activated, a quantity of SCells to be activated per frequency band, one or more frequency bands associated with the one or more SCells to be activated, one or more threshold bandwidths per secondary cell of the one or more SCells to be activated, a total bandwidth across the one or more SCells to be activated, one or more configuration parameters associated with the one or more SCells to be activated, one or more transmission directions associated with activation of the one or more SCells, a quantity of the one or more SCells to be activated in a primary uplink control group, a quantity of the one or more SCells to be activated in a secondary uplink control group, or any combination thereof.

Aspect 13: The method of any of aspects 1 through 12, wherein the plurality of candidate secondary cells comprises a subset of candidate secondary cells from a second plurality of candidate secondary cells.

Aspect 14: The method of any of aspects 1 through 13, wherein the one or more control messages comprise an activation downlink control information message, an activation medium access control-control element message, an additional downlink control information message different than the activation downlink control information message, an additional medium access control-control element message different than the activation medium access control-control element message, a radio resource control message, or any combination thereof.

Aspect 15: A UE for wireless communications, comprising one or more memories storing processor-executable code, and one or more processors coupled with the one or more memories and individually or collectively operable to execute the code to cause the UE to perform a method of any of aspects 1 through 14.

Aspect 16: A UE for wireless communications, comprising at least one means for performing a method of any of aspects 1 through 14.

Aspect 17: A non-transitory computer-readable medium storing code for wireless communications, the code comprising instructions executable by one or more processors to perform a method of any of aspects 1 through 14.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Also, as used herein, the term “a set” may refer to “a set of one” or “a set of one or more.” Thus, the terms “a set,” “a set of one,” “a set of one or more,” and “a set of multiple” may be interchangeable.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive one or more control messages indicative of a plurality of candidate secondary cells and indicative of one or more activation parameters associated with secondary cell activation;
select, by the UE, one or more secondary cells from the plurality of candidate secondary cells to be activated, wherein the selection is in accordance with the one or more activation parameters; and
transmit a report indicative of the one or more secondary cells of the plurality of candidate secondary cells based at least in part on the selection.

2. The UE of claim 1, wherein the one or more activation parameters comprise one or more threshold metrics, and the one or more processors are individually or collectively further operable to execute the code to cause the UE to:
monitor the plurality of candidate secondary cells to generate one or more respective metrics associated with each candidate secondary cell of the plurality of candidate secondary cells; and
select the one or more secondary cells from the plurality of candidate secondary cells based at least in part on one or more respective metrics associated with each candidate secondary cell of the one or more secondary cells satisfying the one or more threshold metrics.

3. The UE of claim 2, wherein the one or more respective metrics comprise a reference signal received power, a reference signal received quality, a signal-to-interference and noise ratio, an energy of a signal, an interference over thermal, a duration of a measurement cycle, a duration of a reporting cycle, or any combination thereof.

4. The UE of claim 2, wherein selection of the one or more secondary cells from the plurality of candidate secondary cells is in accordance with the one or more respective metrics associated with each secondary cell of the one or more secondary cells satisfying the one or more threshold metrics and being the greatest out of the plurality of candidate secondary cells.

5. The UE of claim 1, wherein a first activation parameter of the one or more activation parameters indicates that a second quantity of secondary cells from the plurality of candidate secondary cells are to be activated by the UE, and wherein, to select the one or more secondary cells, the one or more processors are individually or collectively further operable to execute the code to cause the UE to:
select a first quantity of secondary cells of the plurality of candidate secondary cells to be activated in accordance with each secondary cell of the first quantity of secondary cells satisfying a second activation parameter of the one or more activation parameters, wherein the first quantity of secondary cells is less than the second quantity of secondary cells, and wherein the report is indicative of the second activation parameter in accordance with the first quantity of secondary cells being less than the second quantity of secondary cells.

6. The UE of claim 1, wherein the one or more activation parameters correspond to activation of a first quantity of secondary cells, and the one or more processors are individually or collectively further operable to execute the code to cause the UE to:
select the one or more secondary cells from the plurality of candidate secondary cells in accordance with the one or more activation parameters; and
select one or more additional secondary cells for the plurality of candidate secondary cells, wherein the one or more additional secondary cells fail to satisfy the one or more activation parameters, wherein the one or more secondary cells and the one or more additional secondary cells, in combination, comprise the first quantity of secondary cells, and wherein the report indicates that the one or more additional secondary cells fail to satisfy the one or more activation parameters.

7. The UE of claim 1, wherein the one or more control messages indicate one or more tolerances associated with the one or more activation parameters, and wherein the one or more processors are individually or collectively further operable to execute the code to cause the UE to:
select a first subset of the one or more secondary cells from the plurality of candidate secondary cells in accordance with the first subset of the one or more secondary cells satisfying the one or more activation parameters; and
select a second subset of the one or more secondary cells from the plurality of candidate secondary cells in accordance with the second subset of the one or more secondary cells satisfy the one or more activation parameters in accordance with the one or more tolerances.

8. The UE of claim 1, wherein the one or more processors are individually or collectively further operable to execute the code to cause the UE to:
transmit a capability message indicative of a capability of the UE to select the one or more secondary cells from the plurality of candidate secondary cells in accordance with the one or more activation parameters, wherein reception of the one or more control messages is based at least in part on transmission of the capability message.

9. The UE of claim 1, wherein the one or more processors are individually or collectively further operable to execute the code to cause the UE to:
receive one or more second control messages indicative of one or more deactivation parameters associated with secondary cell deactivation; and
transmit a second report indicative of deactivation of at least a subset of the one or more secondary cells that were activated based at least in part on selection of the subset from the one or more secondary cells in accordance with the one or more deactivation parameters.

10. The UE of claim 1, wherein the one or more processors are individually or collectively further operable to execute the code to cause the UE to:
select the one or more secondary cells from the plurality of candidate secondary cells in accordance with the one or more activation parameters and in accordance with one or more conditions associated with the UE, wherein the one or more conditions comprise a latency threshold associated with activation of the one or more secondary cells, a power level of the UE, a threshold quality associated with activation of the one or more secondary cells, or any combination thereof.

11. The UE of claim 1, wherein the one or more control messages indicate a first subset of secondary cells from the plurality of candidate secondary cells to be activated by the UE, wherein selection of the one or more secondary cells is from a remaining subset of secondary cells from the plurality of candidate secondary cells based at least in part on reception of the indication of the first subset of secondary cells, and wherein the one or more processors are individually or collectively further operable to execute the code to cause the user equipment to:
communicate one or more messages with the one or more secondary cells based at least in part on transmission of the report and with the first subset of secondary cells based at least in part on the indication of the first subset of secondary cells.

12. The UE of claim 1, wherein the one or more activation parameters comprises a quantity of the one or more secondary cells to be activated, a quantity of secondary cells to be activated per frequency band, one or more frequency bands associated with the one or more secondary cells to be activated, one or more threshold bandwidths per secondary cell of the one or more secondary cells to be activated, a total bandwidth across the one or more secondary cells to be activated, one or more configuration parameters associated with the one or more secondary cells to be activated, one or more transmission directions associated with activation of the one or more secondary cells, a quantity of the one or more secondary cells to be activated in a primary uplink control group, a quantity of the one or more secondary cells to be activated in a secondary uplink control group, a quantity of the one or more secondary cells to be activated in a first cell group, a quantity of the one or more secondary cells to be activated in a second cell group, or any combination thereof.

13. The UE of claim 1, wherein the plurality of candidate secondary cells comprises a subset of candidate secondary cells from a second plurality of candidate secondary cells.

14. The UE of claim 1, wherein the one or more control messages comprise an activation downlink control information message, an activation medium access control-control element message, an additional downlink control information message different than the activation downlink control information message, an additional medium access control-control element message different than the activation medium access control-control element message, a radio resource control message, or any combination thereof.

15. A method for wireless communications at a user equipment (UE), comprising:
receiving one or more control messages indicative of a plurality of candidate secondary cells and indicative of one or more activation parameters associated with secondary cell activation;
selecting, by the UE, one or more secondary cells from the plurality of candidate secondary cells to be activated, wherein the selection is in accordance with the one or more activation parameters; and
transmitting a report indicative the one or more secondary cells of the plurality of candidate secondary cells based at least in part on the selection.

16. The method of claim 15, wherein the one or more activation parameters comprise one or more threshold metrics, the method further comprising:
monitoring the plurality of candidate secondary cells to generate one or more respective metrics associated with each candidate secondary cell of the plurality of candidate secondary cells; and
selecting the one or more secondary cells from the plurality of candidate secondary cells based at least in part on one or more respective metrics associated with each secondary cell of the one or more secondary cells satisfying the one or more threshold metrics.

17. The method of claim 15, wherein a first activation parameter of the one or more activation parameters indicates that a second quantity of secondary cells from the plurality of candidate secondary cells are to be activated by the UE, and wherein selecting the one or more secondary cells comprises:
selecting a first quantity of secondary cells of the plurality of candidate secondary cells to be activated in accordance with each secondary cell of the first quantity of secondary cells satisfying a second activation parameter of the one or more activation parameters, wherein the first quantity of secondary cells is less than the second quantity of secondary cells, and wherein the report is indicative of the second activation parameter in accordance with the first quantity of secondary cells being less than the second quantity of secondary cells.

18. The method of claim 15, wherein the one or more activation parameters correspond to activation of a first quantity of secondary cells, wherein a second quantity of the one or more secondary cells is less than the first quantity of secondary cells, and wherein the method further comprises:
selecting the one or more secondary cells from the plurality of candidate secondary cells in accordance with the one or more activation parameters; and
selecting one or more additional secondary cells for the plurality of candidate secondary cells, wherein the one or more additional secondary cells fail to satisfy the one or more activation parameters, wherein the one or more secondary cells and the one or more additional secondary cells, in combination, comprise the first quantity of secondary cells, and wherein the report indicates that the one or more additional secondary cells fail to satisfy the one or more activation parameters.

19. The method of claim 15, further comprising:
transmitting a capability message indicative of a capability of the UE to select the one or more secondary cells from the plurality of candidate secondary cells in accordance with the one or more activation parameters, wherein reception of the one or more control messages is based at least in part on transmission of the capability message.

20. A non-transitory computer-readable medium storing code for wireless communications, the code comprising instructions executable by one or more processors to:
receive one or more control messages indicative of a plurality of candidate secondary cells and indicative of one or more activation parameters associated with secondary cell activation;
select, by a user equipment, one or more secondary cells from the plurality of candidate secondary cells to be activated, wherein the selection is in accordance with the one or more activation parameters; and
transmit a report indicative of the one or more secondary cells of the plurality of candidate secondary cells based at least in part on the selection.
